(19) United States
(12) Patent Application Publication
(10) Pub. No.: US 2021/0133729 A1
(43) Pub. Date: May 6, 2021

(54) BLOCKCHAIN TRANSACTION CONTROL BASED ON PRIVATE KEY MANAGEMENT

(71) Applicant: SONY CORPORATION, Tokyo (JP)

(72) Inventors: SADAYOSHI MURAO, BANGALORE (IN); SRINIVAS PINGILI, BANGALORE (IN)

(21) Appl. No.: 16/670,309

(22) Filed: Oct. 31, 2019

(51) Int. Cl. G06Q 20/36; H04L 9/32; G06Q 20/38

(52) U.S. Cl. CPC G06Q 20/3674; H04L 9/3234; G06Q 20/389; G06Q 2220/00; G06Q 20/38215; H04L 2209/38; H04L 2209/56; G06Q 20/3829

(57) ABSTRACT

A wallet management apparatus for blockchain transaction control based on private key management is provided. The wallet management apparatus includes a memory that stores smart contract information associated with each user of a plurality of users. The wallet management apparatus includes circuitry that receives a first request for a first transaction on a blockchain network from a first administrator device associated with a first administrator. The circuitry retrieves first token information from the first request. The first token information indicates an association between the first administrator and a first user. The circuitry validates the first administrator based on the first token information and the smart contract information. The circuitry extracts a first private key associated with a first user device of the first user based on the validation and the retrieved first token information, and controls the first transaction on the blockchain network based on the first private key.

### CROSS-REFERENCE TO RELATED APPLICATIONS/INCORPORATION BY REFERENCE

None.

### FIELD

Various embodiments of the disclosure relate to blockchain technology. More specifically, various embodiments of the disclosure relate to an apparatus and a method for blockchain transaction control based on private key management.

### BACKGROUND

Advancements in the field of financial transaction have led to increase in use of cryptographic wallets and crypto currencies. Typically, a user may utilize different authentication schemes associated with a cryptographic wallet to control a transaction on a network. However, in certain scenarios users may find difficulties in the management of the cryptographic wallet to perform different transactions on the network. Furthermore, users may be unaware about secure methods to be followed to complete a transaction on the network using the cryptographic wallet.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

An apparatus and a method for blockchain transaction control based on private key management, are provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIGS. 1A and 1B, collectively illustrate, a block diagram that illustrates an exemplary network environment for blockchain transaction control based on private key management, in accordance with an embodiment of the disclosure.

FIG. 2 is a block diagram that illustrates an exemplary wallet management apparatus for blockchain transaction control based on private key management, in accordance with an embodiment of the disclosure.

FIG. 3 depicts a sequence diagram for blockchain transaction control based on private key management, in accordance with an embodiment of the disclosure.

FIG. 4 depicts a sequence diagram for blockchain transaction control based on private key management for a request from a new user, in accordance with an embodiment of the disclosure.

FIG. 5 depicts a data relationship for blockchain transaction control based on private key management, in accordance with an embodiment of the disclosure.

FIG. 6 illustrates exemplary operations for a first scenario for transfer of ownership of transactions on the blockchain network, in accordance with an embodiment of the disclosure.

FIG. 7 illustrates exemplary operations for a second scenario for transfer of ownership of transactions on the blockchain network, in accordance with an embodiment of the disclosure.

FIG. 8 is a flowchart that illustrates an exemplary method for blockchain transaction control based on private key management, in accordance with an embodiment of the disclosure.

### DETAILED DESCRIPTION

The following described implementations may be found in the disclosed apparatus and method for blockchain transaction control based on private key management. Exemplary aspects of the disclosure provide a wallet management apparatus for blockchain transaction control based on private key management. The disclosed wallet management apparatus may include a memory configured to store smart contract information associated with each of a plurality of users. The smart contract information may include delegation agreement information between each user of the plurality of users and a first administrator associated with the wallet management apparatus. In contrast to conventional systems, the disclosed wallet management apparatus may be configured to delegate the first administrator to initiate a transaction on the blockchain network for or on behalf of a first user of the plurality of users. The wallet management apparatus may not share a private key (i.e. associated with a first cryptographic wallet of the first user) with the first administrator. Instead, the disclosed wallet management apparatus may share token information (i.e. associated with the first user) with a first administrator device of the first administrator. The token information may provide a reference to the private key which may be stored in a secured database associated with the wallet management apparatus. Hence, the first administrator device may be unaware of the private key of the first cryptographic wallet of the first user, and digital assets stored in the first cryptographic wallet of the first user may be secure. Furthermore, the wallet management apparatus may control a first transaction on the blockchain network using a cryptographic wallet associated with the first administrator, although an ownership of the first transaction may be with the first user. Alternatively stated, the first transaction may be controlled with reference to the identification information (such as a name) of the first user, but the digital assets used for the first transaction may be from the cryptographic wallet associated with the first administrator which may request the wallet management apparatus to initiate the first transaction on the blockchain network on the behalf of the first user.

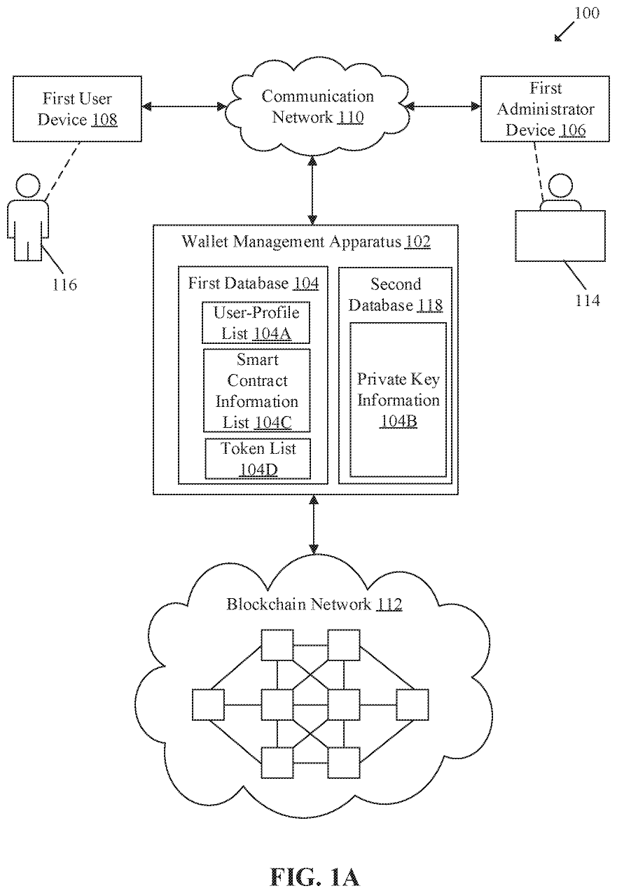

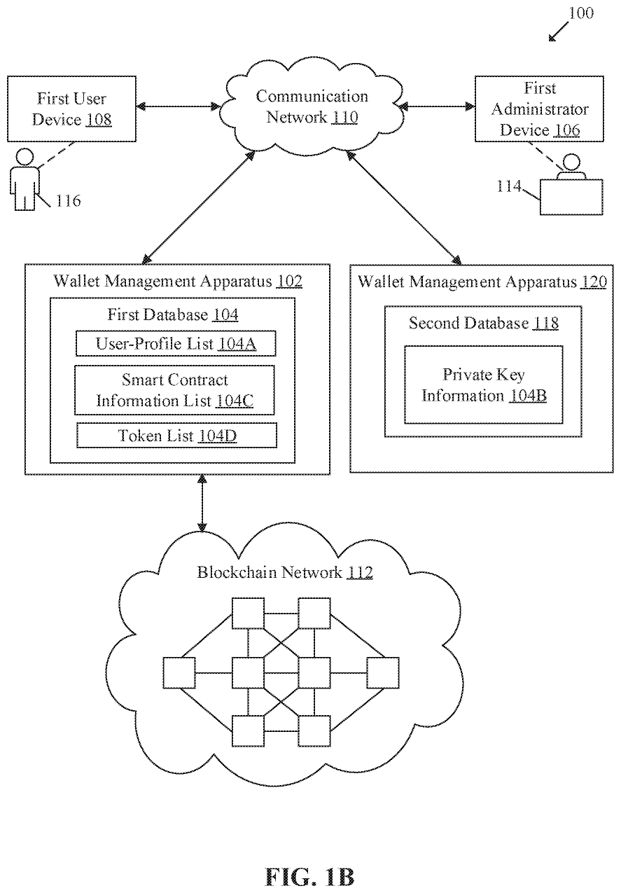

FIGS. 1A and 1B, collectively illustrate, a block diagram that illustrates an exemplary network environment for blockchain transaction control based on private key management, in accordance with an embodiment of the disclosure. With reference to FIG. 1A, there is shown a network environment 100. The network environment 100 may include a wallet management apparatus 102, a first administrator device 106, and a first user device 108. The wallet management apparatus 102 may include a first database 104 and a second database 118. The wallet management apparatus 102, the first administrator device 106, and the first user device 108 may be communicatively coupled to each other, via a communication network 110. The wallet management apparatus 102 may be communicatively coupled to a blockchain network 112. A first administrator 114 may be associated with the first administrator device 106. A first user 116 may be associated with the first user device 108.

The wallet management apparatus 102 may comprise suitable logic, circuitry, and interfaces that may be configured to receive a first request for a first transaction on the blockchain network 112 from the first administrator device 106 associated with the first administrator 114. The received first request for the first transaction may be received from the first administrator device 106 on behalf of the first user 116. The wallet management apparatus 102 may be further configured to control the first transaction on the blockchain network 112, based on a first private key associated with the first user device 108 of the first user 116. Examples of the wallet management apparatus 102 may include, but are not limited to, a computing device, a mainframe machine, a computer work-station, a server, a smart phone, a laptop, and/or a consumer electronic (CE) device.

The first database 104 may comprise suitable logic, circuitry, and interfaces that may be configured to store a user-profile list 104A, smart contract information list 104C, and a token list 104D. The wallet management apparatus 102 may include the second database 118 which may be secured to store private key information 104B. The first database 104 may be different from the second database 118. In some embodiments, the first database 104 and the second database 118 may be internal part of the wallet management apparatus 102 as shown in FIG. 1A. In some embodiments, the first database 104 and the second database 118 may be stored in different wallet management apparatuses. For example, as shown in FIG. 1B, the second database 118 may be stored in another wallet management apparatus 120, which may be different from the wallet management apparatus 102. The first database 104 and the second database 118 may be an organized collection of data that may be stored in a memory of the wallet management apparatus 102. In some embodiments, the first database 104 and the second database 118 may be stored on an external server associated with the wallet management apparatus 102. Examples of the external server may include, but are not limited to, a database server, a file server, a web server, a media server, a cloud server, an application server, a mainframe server, a gaming server, or other types of servers.

The first administrator device 106 may comprise suitable logic, circuitry, and interfaces that may be configured to initiate a request for a first transaction on the blockchain network 112 on behalf of the first user 116. The first administrator 114 may be associated with the first administrator device 106. The first administrator device 106 may be further configured to request for the first transaction on the blockchain network 112, based on first token information (associated with the first user 116) stored with the first administrator device 106. The first token information may include user-profile information associated or linked with the first user 116. The first administrator device 106 may be connected or communicate with the first user device 108 of the first user 116 using the stored user-profile information. Examples of the first administrator device 106 may include, a computing device, a smartphone, an online service (such as an application) running on the smartphone, a cryptographic wallet, a computer work-station, a server, a mainframe machine, and/or a consumer electronic (CE) device. In an embodiment, the first administrator device 106 may be a device associated with an administrator (for example the first administrator 114) of an organization (for example a school, a college, a hospital, an institute, a company, or government).

The first user device 108 may comprise suitable logic, circuitry, and interfaces that may be configured to request the first transaction on the blockchain network 112. The first user 116 may be associated with the first user device 108. In one or more embodiments, the first user device 108 may be configured to transmit (or share) a first private key associated with the first user device 108 or the first user 116 to the wallet management apparatus 102. The first user device 108 may be further configured to receive a notification of completion of the first transaction from the wallet management apparatus 102. Examples of the first user device 108 may include, a computing device, a smartphone, a mobile phone, an online service (such as an application) running on the smartphone, a cryptographic wallet, a computer work-station, a server, laptop, a mainframe machine, and/or a consumer electronic (CE) device. In accordance with an embodiment, examples of the first user 116 may include, but are not limited to, a student, an employee, a worker, a participant, a customer, or a member of a group associated with the organization with which the first administrator 114 may also be associated.

The communication network 110 may include a communication medium through which the wallet management apparatus 102, the first administrator device 106, and the first user device 108 may communicate with each other. Examples of the communication network 110 may include, but are not limited to, the Internet, a cloud network, a Wireless Fidelity (Wi-Fi) network, a Personal Area Network (PAN), a Local Area Network (LAN), or a Metropolitan Area Network (MAN). Various devices in the network environment 100 may be configured to connect to the communication network 110, in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), Message Queuing Telemetry Transport (MQTT) protocol, File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

The blockchain network 112 may be a distributed network, such as a peer-to-peer (P2P) communication network, that includes a plurality of P2P nodes (for example computing devices). The blockchain network 112 may include a decentralized or a distributed ledger that may record information associated with a plurality of transactions that occur between a plurality of users or a plurality of administrators on the blockchain network 112. The information associated with each of the plurality of transactions may be recorded in a plurality of blocks which may be time-stamped. Each block of the plurality of blocks may include information associated with a particular transaction and a time-stamp associated with the corresponding block in a cryptographic format. The plurality of blocks on the blockchain network 112 may be managed by the plurality of P2P nodes. In some embodiments, the blockchain network 112 may include a plurality of blockchains each of which may include a set of blocks.

The wallet management apparatus 102 may include the first database 104 and the second database 118. The first database 104 may be configured to store the user-profile list 104A, the smart contract information list 104C, and the token list 104D. The second database 118 may be configured to store the private key information 104B. As shown in FIG. 1B, the second database 118 may be stored in another wallet management apparatus 120 different from the wallet management apparatus 102. The storage of the private key information 104B in the other wallet management apparatus 120 may provide more secure method to anonymize user information (such as the private key information 104B). The user-profile list 104A may include user-profile information associated with each user of the plurality of users, such as the first user 116. The plurality of users may be subscribed to the wallet management apparatus 102. The stored user-profile information of each user of the plurality of users may correspond to user identification information of each user. For example, user-profile information associated with the first user 116 may correspond to the user identification information of the first user 116. Examples of the user identification information associated with the first user 116 may include, but are not limited to, a name of the first user 116, a user id number associated with the first user 116, contact information of the first user 116, an email address of the first user 116, or other identification information associated with the first user 116.

A user device of each user (for example the first user 116) of the plurality of users may be associated with a public key and a private key. The public key may be a cryptographic key that may be publicly accessible. The public key may be utilized to encrypt data blocks. The private key may be a cryptographic key associated with the user device that may be known only to the user of the corresponding user device. The private key information 1048 stored in the second database 118 (secured) may include the private key associated with the user device or with each user of the plurality of users. For example, the private key information 104B may include a first private key associated with the first user device 108 of the first user 116. The first private key may be a cryptographic key that may be utilized to decrypt data blocks intended for the first user 116 on the blockchain network 112. The first private key may be further utilized to verify and sign a particular data block based on the identification information of the first user 116 on the blockchain network 112. For example, the first private key may be utilized by the first user 116 to complete a transaction for exchange of crypto currency on the blockchain network 112. The private key associated with the user device may be confidential to the corresponding user of the plurality of users.

The smart contract information list 104C may include smart contract information associated with each user of the plurality of users, such as the first user 116. The smart contract information may be a self-executable program or a computer code that may include a set of rules to be followed between multiple parties (or nodes) on the blockchain network 112. The multiple parties may agree to interact with each other on the blockchain network 112 based on the set of rules included in the smart contract information. The smart contract information may be utilized to transfer digital assets, such as crypto currencies, among the multiple parties on the blockchain network 112. The smart contract information may be further utilized to verify that a transaction on the blockchain network 112 is compliant with applicable set of rules and other restrictions.

The smart contract information associated with each user may further include delegation agreement information between the corresponding user and the first administrator 114 associated with the first administrator device 106. The delegation agreement information between the corresponding user and the first administrator 114 may indicate that the first administrator 114 associated with the first administrator device 106 may be delegated to initiate or control a transaction on the blockchain network 112 on behalf of the corresponding user. For example, the delegation agreement information between the first user 116 and the first administrator 114 may indicate that the first administrator 114 associated with the first administrator device 106 may be delegated to initiate or control the transaction on the blockchain network 112 on behalf of the first user 116.

The token list 104D may include token information associated with each user of the plurality of users, such as the first user 116. The token information associated with each user may indicate an association between the corresponding user and the first administrator 114. For example, first token information may indicate an association between the first user 116 and the first administrator 114 using the user-profile information included in the first token information. The association may indicate that the first administrator 114 may be authorized or delegated to initiate or control transactions on the blockchain network 112 on behalf of the first user 116. The first token information may include, but is not limited to, a token identification number, a reference to the user-profile information associated with the first user 116, a reference to identification information of the first administrator 114, and the smart contract information associated with the first user 116. The first token information may further include first private key reference information which may refer to an encrypted version of the first private key associated with the first user device 108 of the first user 116. The encrypted version of the first private key may be stored in the second database 118 (either of the wallet management apparatus 102 or the other wallet management apparatus 120 shown in FIG. 1B). The user-profile information of the first user 116 and the identification information of the first administrator 114 in the first token information may indicate the association between the first administrator 114 and the first user 116.

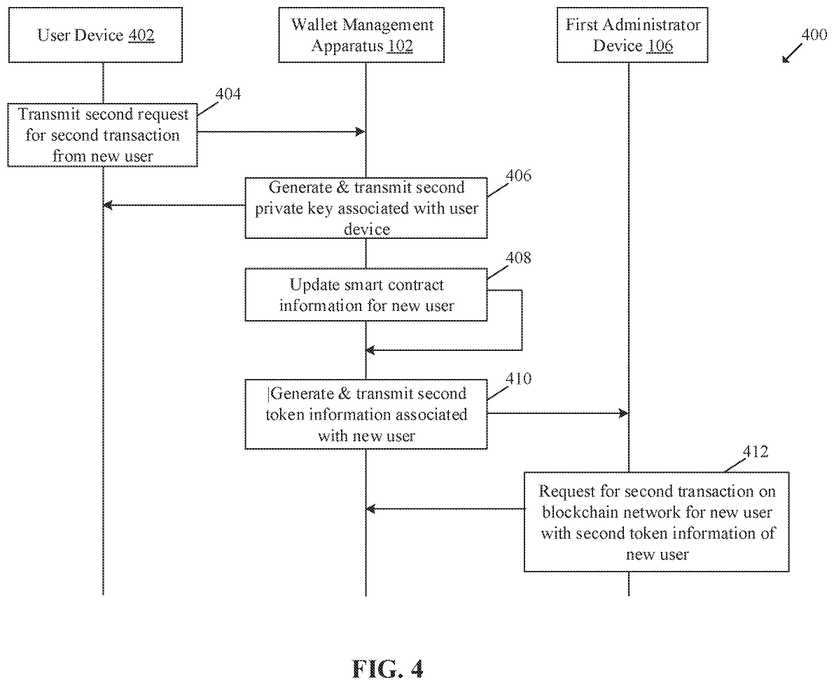

The wallet management apparatus 102 may be further configured to update the token list 104D based on a change in the token information associated with each of the plurality of users. The change in the token information associated with each of the plurality of users may be, but is not limited to, due to change in user identification information, change in identification information of the administrator, change in the smart contract information, addition or deletion of users subscribed to the wallet management apparatus 102. For example, if there is a change in a user name of a user of the plurality of users, then the wallet management apparatus 102 may be configured to update the token information associated with the user and update the token list 104D based on the updated token information. In another example, if a user is no longer subscribed to the wallet management apparatus 102, then the wallet management apparatus 102 may be configured to delete the token information associated with the user and update the token list 104D based on the deletion. Similarly, if a new user is subscribed to the wallet management apparatus 102, then the wallet management apparatus 102 may be further configured to generate token information associated with the new user and update the token list 104D based on the generated token information associated with the new user. Addition of a new user and generation of the token information associated with the new user is further shown and described, for example, in FIG. 4.

In accordance with an embodiment, the wallet management apparatus 102 may be further configured to generate an administrator profile associated with each of a plurality of administrators. The plurality of administrators may include the first administrator 114. Each of the plurality of administrators may be associated with an administrator device (for example the first administrator 114 may be associated with the first administrator device 106). The administrator profile of the first administrator 114 may include, but is not limited to, an administrator identification number of the first administrator 114, an administrator name of the first administrator 114, or a list of a set of users associated with the first administrator 114.

In accordance with an embodiment, the first administrator 114 may be associated with the set of users, based on delegation agreement information between each of the set of users and the first administrator 114. The first administrator 114 may be delegated or authorized to initiate a transaction on the blockchain network 112 on behalf of the set of users. The wallet management apparatus 102 may be further configured to update the administrator profile of the first administrator 114, based on a change in the set of users associated with the first administrator 114.

In operation, the wallet management apparatus 102 may be further configured to receive a first request for a first transaction on the blockchain network 112 from the first administrator device 106 associated with the first administrator 114. The wallet management apparatus 102 may be further configured to retrieve the first token information from the received first request received from the first administrator 114. The first token information may indicate the association between the first administrator 114 and the first user 116 from the plurality of users. The first administrator device 106 or the first administrator 114 may be delegated or authorized to request the first transaction on behalf of the first user 116 on the blockchain network 112.

The wallet management apparatus 102 may be further configured to validate the first administrator 114 based on the retrieved first token information and the stored smart contract information. The wallet management apparatus 102 may be further configured to determine a presence of the retrieved first token information, associated with the first user 116, in the token list 104D stored in the first database 104. The wallet management apparatus 102 may be further configured to validate the first administrator 114 based on the determined presence of the retrieved first token information in the token list 104D. In some embodiments, the wallet management apparatus 102 may be further configured to check the delegation agreement information between the first user 116 and the first administrator 114 in the stored smart contract information. The wallet management apparatus 102 may be further configured to validate the first administrator 114 and the first administrator device 106, based on the delegation agreement information between the first user 116 and the first administrator 114. The first administrator 114 and/or the first administrator device 106 may be validated in case the delegation agreement information between the first user 116 and the first administrator 114 indicates that the first administrator 114 is delegated or authorized to initiate the first transaction on the blockchain network for the first user 116.

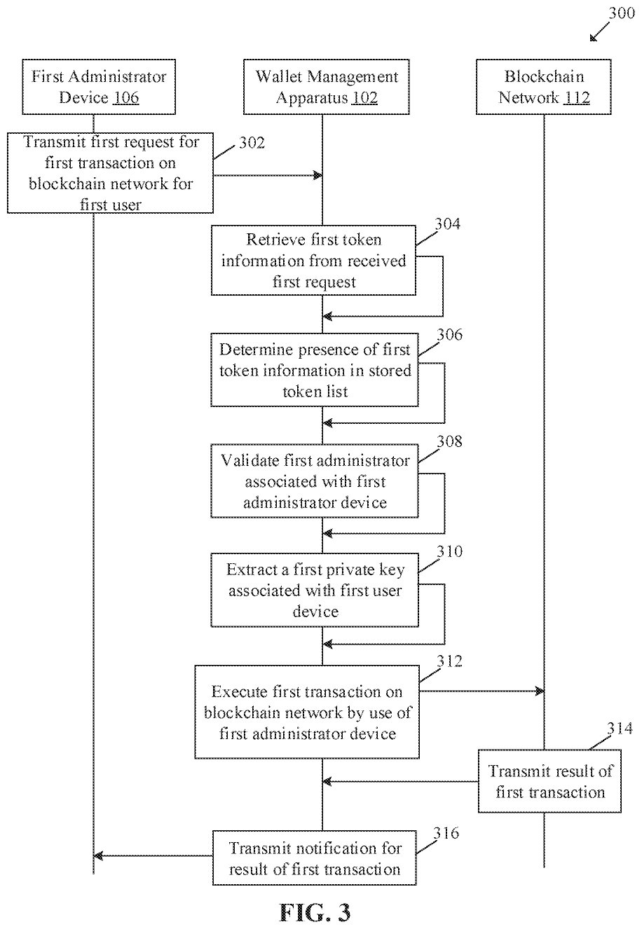

The wallet management apparatus 102 may be further configured to extract a first private key associated with the first user device 108 of the first user 116 based on the retrieved first token information and the validation. The wallet management apparatus 102 may be further configured to extract the first private key from the plurality of private keys stored in the private key information 104B (i.e. in the second database 118) based on the validation and the first private key reference information stored in the retrieved first token information. The extraction of the first private key associated with the first user device 108 of the first user 116 may be described in detail, for example, in FIG. 3.

The wallet management apparatus 102 may be further configured to control the first transaction on the blockchain network 112 based on the extracted first private key of the first user device 108 or the first user 116. The wallet management apparatus 102 may be further configured to execute the first transaction on the blockchain network 112 by use of the first administrator device 106 associated with the first administrator 114. For example, the wallet management apparatus 102 may be configured to complete the first transaction for the first user 116 by using the digital assets (such as crypto currencies) from a cryptographic wallet associated with the first administrator 114. An ownership of the first transaction may be with the first user 116 although the transaction may be executed using the first administrator device 106 of the first administrator 114 (who is authorized to initiate or control the transaction on behalf of the first user 116). Further, the first private key associated with the first user device 108 or the first user 116 may not be shared with the first administrator device 106 of the first administrator 114. Instead, the first token information associated with the first user device 108 of the first user 116 may be shared with the first administrator device 106 of the first administrator 114. The execution of the first transaction on the blockchain network is further described in detail, for example, in FIG. 3.

The wallet management apparatus 102 may be further configured to block the first transaction requested on the blockchain network 112, based on an invalidation of the first administrator 114. The wallet management apparatus 102 may be further configured to block the first transaction based on the delegation agreement information (between the first user 116 and the first administrator 114) stored in the smart contract information. For example, if the first administrator 114 is not delegated or authorized to request the first transaction on the blockchain network 112 on behalf of the first user 116, then the wallet management apparatus 102 may be configured to block the first transaction on the blockchain network 112.

In accordance with an embodiment, the wallet management apparatus 102 may be further configured to transmit a notification for completion of the first transaction on the blockchain network 112 to the first administrator device 106 which may be associated with the first administrator 114 and to the first user device 108 which may be associated with the first user 116. The wallet management apparatus 102 may be further configured to transmit the notification as a status of the first transaction on the blockchain network 112. For example, if the first transaction is completed on the blockchain network 112, the wallet management apparatus 102 may transmit the notification for the completion of the first transaction to the first administrator device 106 and the first user device 108. In another example, if the first transaction is blocked on the blockchain network 112, the wallet management apparatus 102 may transmit the notification for the blocked transaction to the first administrator device 106 and the first user device 108.

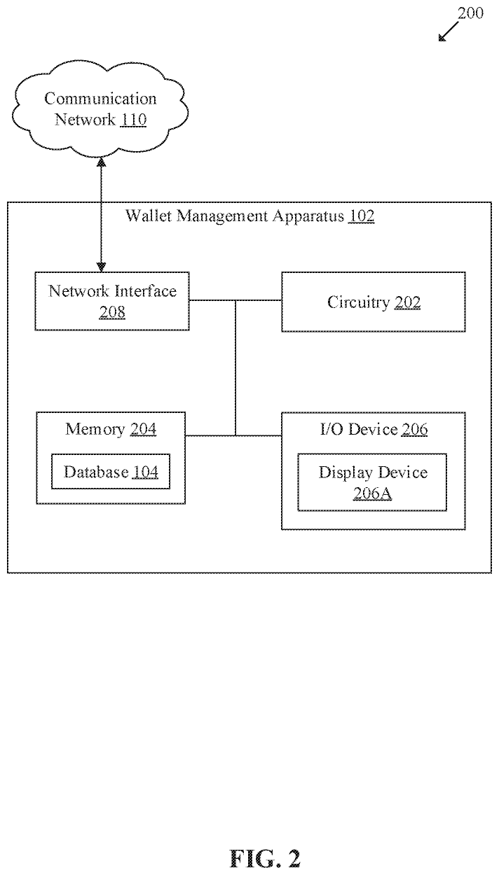

FIG. 2 is a block diagram that illustrates an exemplary wallet management apparatus for blockchain transaction control based on private key management, in accordance with an embodiment of the disclosure. FIG. 2 is explained in conjunction with elements from FIGS. 1A-1B. With reference to FIG. 2, there is shown a block diagram 200 of the wallet management apparatus 102. The wallet management apparatus may include circuitry 202. The wallet management apparatus 102 may further include a memory 204 and an input/output (I/O) device 206. An example of the I/O device 206 may be a display device 206A. The wallet management apparatus 102 may further include a network interface 208. The circuitry 202 may be configured to communicate with the first administrator device 106 and the first user device 108 by use of the network interface 208. The circuitry 202 may be communicatively coupled to the memory 204, the I/O device 206, and the network interface 208.

The circuitry 202 may comprise suitable logic, circuitry, and interfaces that may be configured to execute one or more instructions stored in the memory 204. The circuitry 202 may be configured to receive the first request for the first transaction on the blockchain network 112 from the first administrator device 106 associated with the first administrator 114. The circuitry 202 may be further configured to retrieve first token information from the received first request. The circuitry 202 may be further configured to validate the first administrator 114 based on the retrieved first token information. The circuitry 202 may be further configured to extract the first private key associated with the first user device 108 based on the first token information and the validation. The circuitry 202 may be further configured to control the first transaction on the blockchain network 112 based on the extracted the first private key.

The circuitry 202 may comprise one or more specialized processing units, which may be implemented as a separate processor or circuitry in the wallet management apparatus 102. In an embodiment, the one or more specialized processing units and the circuitry 202 may be implemented as an integrated processor or a cluster of processors that perform the functions of the one or more specialized processing units and the circuitry 202, collectively. The circuitry 202 may be implemented based on a number of processor technologies known in the art. Examples of implementations of the circuitry 202 may be an X86-based processor, a Reduced Instruction Set Computing (RISC) processor, an Application-Specific Integrated Circuit (ASIC) processor, a Complex Instruction Set Computing (CISC) processor, a microcontroller, a central processing unit (CPU), a Graphics Processing Unit (GPU), and/or other control circuits.

The memory 204 may comprise suitable logic, circuitry, and interfaces that may be configured to store the one or more instructions to be executed by the circuitry 202. The memory 204 may further include the first database 104, which may include the user-profile list 104A, the smart contract information list 104C, and the token list 104D as described, for example, in FIGS. 1A-1B. The memory 204 may further include the secured second database 118 which may include the private key information 104B which may be only accessed by the first user 116 (for example), but not by the first administrator 114. The memory 204 may be implemented as one of a persistent data storage, a non-persistent data storage, or a combination thereof. Some examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The I/O device 206 may comprise suitable logic, circuitry, and interfaces that may be configured to receive a user input and provide an output based on the received user input. The I/O device 206 which may include various input and output devices, may be configured to communicate with the circuitry 202. Examples of the I/O device 206 may include, but are not limited to, a touch screen, a keyboard, a mouse, a joystick, a microphone, a display device (for example, the display device 206A), and a speaker.

The display device 206A may comprise suitable logic, circuitry, and interfaces that may be configured to display the notification for the completion of the first transaction on the blockchain network 112. In some embodiments, the display device 206A may configured to display information about the first user 116, the first administrator 114, and/or updates about the first transaction. In some embodiments, the display device 206A may be an external display device associated with the wallet management apparatus 102. The display device 206A may be a touch screen which may enable a user to provide a user-input via the display device 206A. The display device 206A may be realized through several known technologies such as, but not limited to, at least one of a Liquid Crystal Display (LCD) display, a Light Emitting Diode (LED) display, a plasma display, or an Organic LED (OLED) display technology, or other display devices.

The network interface 208 may comprise suitable logic, circuitry, and interfaces that may be configured to facilitate communication between the wallet management apparatus 102, the first administrator device 106, and the first user device 108, via the communication network 110. The network interface 208 may be implemented by use of various known technologies to support wired or wireless communication of the wallet management apparatus 102 with the communication network 110. The network interface 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry. The network interface 208 may be configured to communicate via wireless communication with networks, such as the Internet, an Intranet or a wireless network, such as a cellular telephone network, a wireless local area network (LAN), and a metropolitan area network (MAN).

The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a protocol for email, instant messaging, and a Short Message Service (SMS). The operations executed by the circuitry 202 are described in detail, for example, in FIGS. 3, 4, 5, 6, and 7.

FIG. 3 depicts a sequence diagram for blockchain transaction control based on private key management, in accordance with an embodiment of the disclosure. FIG. 3 is explained in conjunction with elements from FIGS. 1A-1B and FIG. 2. With reference to FIG. 3, there is shown a sequence diagram 300 that illustrates the blockchain transaction control based on the private key management. The sequence diagram 300 may include sequence of operations from 302 to 316 which may be executed by various elements of the network environment 100, such as the wallet management apparatus 102, the first administrator device 106, and the blockchain network 112.

At 302, the first administrator device 106 may be configured to transmit a first request for a first transaction on the blockchain network 112 to the wallet management apparatus 102. The first request may be transmitted by the first administrator device 106 on behalf of the first user 116. In accordance with an embodiment, the first request for the first transaction may correspond to a request for transfer of digital securities or digital assets on the blockchain network 112. For example, the first transaction may be a transaction for transfer of crypto currencies on the blockchain network 112. The first administrator device 106 may be configured to request for the first transaction on the blockchain network for the first user device 108 of the first user 116. The first user device 108 may be an electronic device (such as a smartphone) or an online service on the first user device 108 for the execution of electronic transactions. For example, the first user device 108 may be a cryptographic wallet associated with the first user 116. The first administrator device 106 may be configured to request for the first transaction for the first user 116 based on the delegation agreement between the first user 116 and the first administrator 114. According to the delegation agreement between the first user 116 and the first administrator 114, the first administrator 114 or the first administrator device 106 may be authorized or delegated to request for the first transaction on the blockchain network 112 on behalf of the first user 116. In some embodiments, the first administrator device 106 may receive the first request for the first transaction from the first user device 108.

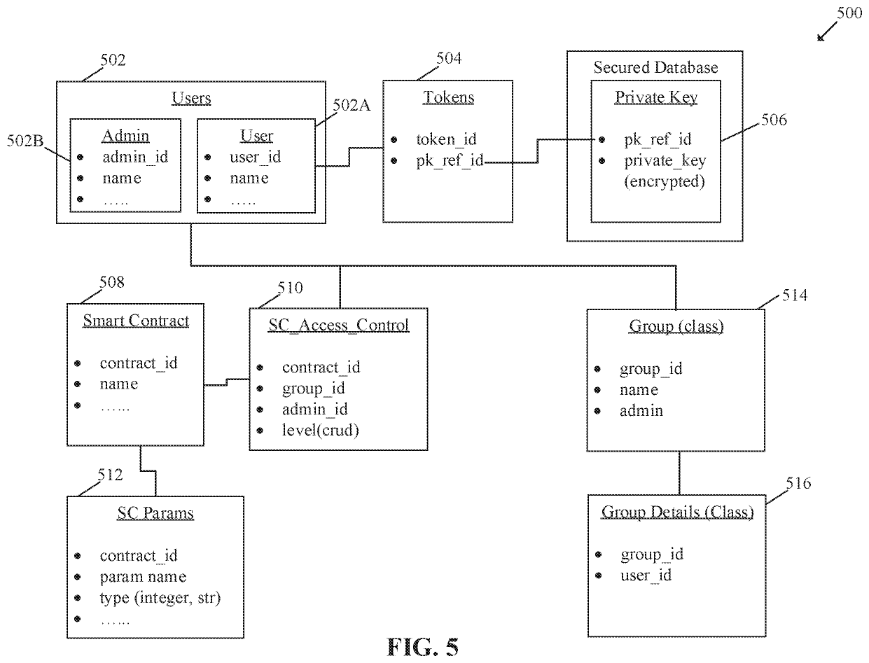

At 304, the wallet management apparatus 102 may be configured to retrieve the first token information from the first request received from the first administrator device 106. The first token information may be associated with the first user 116 and may include identification information (for example user ID) of the first user 116, identification information of the first administrator 114, a token identification number, and the first private key reference information. The first private key reference information may refer to the first private key (i.e. stored in the second database 118) associated with the first user device 108 or the first user 116. In some embodiments, the first token information may include personal data (for example marks of students, salary details of employee, diagnostic data of patient, etc) associated with the first user 116 or data associated with the organization of the first administrator 114. The identification information of the first user 116 and the identification information of the first administrator 114 in the same first token information may indicate the association between the first administrator 114 and the first user 116. The first private key associated with the first user device 108 may be unknown to the first administrator device 106. The first administrator device 106 may have the first token information that may refer to the encrypted version of the first private key through the stored first private key reference information (as shown in FIG. 5).

At 306, the wallet management apparatus 102 may be configured to determine a presence of the retrieved first token information in the stored token list 104D. In other words, the wallet management apparatus 102 may be configured to determine if the received first token information is present in the stored token list 104D. The wallet management apparatus 102 may be configured to match the identification information of the first user 116/the first administrator 114 included in the first token information and stored in the token list 104D to determine the presence of the retrieved first token information. The presence may indicate that the first user 116 and the first administrator 114 mentioned by the first token information may be authorized to perform the transaction on the blockchain network 112 through the wallet management apparatus 102.

At 308, the wallet management apparatus 102 may be further configured to validate the first administrator 114 associated with the first administrator device 106 based on the first token information and the stored smart contract information. The wallet management apparatus 102 may be further configured to validate the first administrator 114 based on the determined presence of the first token information in the token list 104D as described at step 306. In some embodiments, the wallet management apparatus 102 may be further configured to validate whether the first administrator 114 is authorized to request the first transaction for the first user 116, based on the smart contract information stored in the smart contract information list 104C. The smart contract information may include the delegation agreement information between the first user 116 and the first administrator 114. The wallet management apparatus 102 may be further configured to determine that the first administrator 114 is authorized or delegated to perform transaction on the blockchain network 112 on behalf of the first user 116 based on the delegation agreement information included in the smart contract information. The wallet management apparatus 102 may be configured to retrieve a public key associated with the first administrator device 106 to check the ownership and/or the delegation in the delegation agreement information included in the smart contract information. Thus, the wallet management apparatus 102 may validate the first administrator 114 based on the delegation agreement information (i.e. between the first user 116 and the first administrator 114) stored in the smart contract information.

In some embodiments, the wallet management apparatus 102 may be further configured to block the first transaction requested on the blockchain network 112, based on an invalidation of the first administrator 114. Therefore, in case the first request received from the first administrator 114 is invalid or not authorized (i.e. received first token information is not included in the token list 104D) the wallet management apparatus 102 may be configured to block the first transaction.

At 310, the wallet management apparatus 102 may be configured to extract the first private key associated with the first user device 108 of the first user 116, based on the validation of the first administrator 114 associated with the first administrator device 106. The wallet management apparatus 102 may be further configured to extract the first private key associated with the first user device 108 from the private key information 104B (i.e. stored in the second database 118). The wallet management apparatus 102 may use the first private key reference information stored in the retrieved first token information to access the first private key. The first private key reference information may provide reference to the encrypted version of the first private key, that may be associated with the first user device 108 and stored in the second database 118 (either of the wallet management apparatus 102 or the other wallet management apparatus 120). In accordance with an embodiment, the wallet management apparatus 102 may be configured to decrypt the encrypted version of the first private key retrieved based on the first private key reference information. The wallet management apparatus 102 may be further configured to extract the first private key associated with the first user device 108 based on the decryption of the encrypted version of the first private key.

In some embodiments, the wallet management apparatus 102 may be configured to store a plurality of private keys each of which is associated with corresponding user of the plurality of users. The plurality of private keys may be stored in the private key information 104B stored in the first database 104 of the wallet management apparatus 102. The wallet management apparatus 102 may be further configured to extract the first private key from the stored plurality of private keys based on the first private key reference information included in the retrieved first token information and the validation of the first administrator 114. The extracted first private key may be associated with a cryptographic wallet (or the first user device 108) of the first user 116.

At 312, the wallet management apparatus 102 may be further configured to execute the first transaction on the blockchain network 112 by use of the first administrator device 106. The wallet management apparatus 102 may be configured to send a request to execute the first transaction on the blockchain network 112. The wallet management apparatus 102 may be further configured to execute the first transaction on the blockchain network 112 by use of the first administrator device 106 (such as a cryptographic wallet of the first administrator 114). For example, the wallet management apparatus 102 may be configured to use a cryptographic wallet of the first administrator 114 to execute the first transaction. The wallet management apparatus 102 may be further configured to control the execution of the first transaction on the blockchain network 112 by using the extracted first private key associated with the first user device 108 (such as a cryptographic wallet of the first user 116). In some embodiments, the wallet management apparatus 102 may be configured to verify and sign the first transaction by using the first private key associated with the first user device 108 (such as the cryptographic wallet of the first user 116) on the blockchain network 112. The wallet management apparatus 102 may be further configured to link a public key, associated with the first user 116, with the data associated with the first transaction in the blockchain network 112 such that the first user device 108 may anytime access own information (for example data of the first transaction) using the first private key. In response to a receipt of a data request from the fist user device 108 (or the first user 116) to access the data from the blockchain network 112, the wallet management apparatus 102 may retrieve the public key from the smart contract information associated from the first user 116. In some embodiments, the wallet management apparatus 102 may retrieve the public key associated with the first user 116 from the signed first transaction record and may check ownership of the first user 116 for the first transaction. The wallet management apparatus 102 may retrieve the data for the first transaction from the blockchain network 112 based on the checked ownership and may provide the retrieved data to the first user device 108 associated with the first user 116. In accordance with an embodiment, the wallet management apparatus 102 may be configured to use the first administrator device 106 (such as the cryptographic wallet of the first administrator 114) to transfer digital assets, such as crypto currencies to execute the first transaction. Although, the first transaction may be verified and signed with the name of the first user 116 since the first private key is associated with the first user device 108. Hence, the first transaction may be executed for the first user 116 by the first administrator 114. The first transaction may be completed by utilizing digital assets from the first administrator device 106 (such as the cryptographic wallet of the first administrator 114) on behalf of the first user 116. Thus, the first transaction may be controlled on the blockchain network 112 using the first administrator device 106, still an ownership of the first transaction may be with the first user device 108 or the first user 116. In some embodiments, the wallet management apparatus 102 may be configured to retrieve the digital assets (such as the organization wallet) associated with the first administrator device 106 and further control or submit the first transaction on the blockchain network 112 using the retrieved digital assets. In an accordance with an embodiment, the smart contract information list 104C may be updated based on the submitted first transaction.

At 314, the blockchain network 112 may be configured to transmit a result of the first transaction to the wallet management apparatus 102. The blockchain network 112 may be further configured to transmit the result of the first transaction based on the completion of the first transaction on the blockchain network 112. The first transaction may be completed based on the first transaction and the first private key associated with the first user device 108. For example, if the first transaction is complete, the blockchain network 112 may be configured to transmit the result of the first transaction as completed, to the wallet management apparatus 102. Further, if the first transaction is blocked or not completed, the blockchain network 112 may be configured to transmit the result of the first transaction as blocked, to the wallet management apparatus 102. The first transaction may be blocked, for example, due to any discrepancy in the first private key associated with the first user device 108.

At 316, the wallet management apparatus 102 may be further configured to transmit a notification for the result of the first transaction to the first administrator device 106. The notification for the result may be a message for the completion (or rejection) of the first transaction. The wallet management apparatus 102 may be further configured to display the notification of the result of the first transaction on the display device, such as the display device 206A. In one or more embodiments, the wallet management apparatus 102 may be further configured to transmit the notification of the result of the first transaction to the first user device 108. For example, the notification for the result of the transaction may be, but is not limited to, “Completed” or “Blocked”. In some embodiments, the first transaction and the related result are also recorded on the blockchain network 112.

FIG. 4 depicts a sequence diagram for blockchain transaction control based on private key management for a request from a new user, in accordance with an embodiment of the disclosure. FIG. 4 is explained in conjunction with elements from FIGS. 1, 2 and 3. With reference to FIG. 4, there is shown a sequence diagram 400. The sequence diagram 400 may include sequence of operations from 404 to 412 which may be executed by various elements of the network environment 100, such as the wallet management apparatus 102 and the first administrator device 106. The sequence of operations may also be executed by a user device 402 associated with a new user. The new user may be different from each user of the plurality of users that may be subscribed to the wallet management apparatus 102. The user-profile information of the new user may not be stored in the first database 104 of the wallet management apparatus 102. The operations of the user device 402 may correspond to the operations of the first user device 108 of FIGS. 1A-1B.

At 404, the user device 402 may be configured to receive a second request for a second transaction on the blockchain network 112 from the new user. The user device 402 may be further configured to transmit the received second request for the second transaction to the wallet management apparatus 102. The second request for the second transaction may correspond to a request for transfer of digital securities or digital assets on the blockchain network 112 by the new user. The user device 402 may be an electronic device (such as a smartphone) or an online service on the electronic device for the execution of electronic transactions. For example, the user device 402 associated with the new user may be a cryptographic wallet associated with the new user. The new user may be a new subscriber to the wallet management apparatus 102 and the new user may utilize the user device 402 for a transaction on the blockchain network 112 for the first time.

At 406, the wallet management apparatus 102 may be configured to generate a second private key associated with the user device 402 based on the received request for the second transaction. The wallet management apparatus 102 may be further configured to transmit the generated second private key to the user device 402 and store the generated second private key in the private key information 104B (i.e. stored in the second database 118). The second private key may be a cryptographic key that may be associated with the user device 402 or the new user. In some embodiments, the second private key may be utilized to control the second transaction for the new user on the blockchain network 112. In some embodiments, the second private key may be further utilized to verify and sign a particular data block on the blockchain network 112 based on the identification information of the new user. The wallet management apparatus 102 may transmit the second private key to the user device 402 to provide ownership to the new user.

At 408, the wallet management apparatus 102 may be further configured to update the smart contract information in the smart contract information list 104C for the new user. The wallet management apparatus 102 may be further configured to create new delegation agreement information between the new user and the first administrator 114 to update the smart contract information for the new user. Based on the update of the created new delegation agreement information on the smart contract information, the first administrator 114 may be authorized or delegated to initiate transaction on the blockchain network 112 on behalf of the new user. The wallet management apparatus 102 may be further configured to authorize the first administrator 114, associated with the first administrator device 106, to initiate a request for the second transaction on the blockchain network 112 for the new user.

At 410, the wallet management apparatus 102 may be further configured to generate second token information associated with the new user. The generated second token information may indicate an association between the new user and the first administrator 114. The second token information may correspond to the identification information of the new user, identification information of the first administrator 114, a token identification number, second private key reference information which may provide a reference to an encrypted version of the second private key associated with the user device 402 of the new user, and new delegation agreement information between the new user and the first administrator 114. In accordance with an embodiment, the wallet management apparatus 102 may be configured to link the identification information of the new user, the identification information of the first administrator 114, the token identification number, the second private key reference information, and the new delegation agreement information between the new user and the first administrator 114, to generate the second token information.

The wallet management apparatus 102 may be further configured to update the token list 104D based on the generated second token information. In some embodiments, the wallet management apparatus 102 may be further configured to add the generated second token information in the stored token list 104D. The wallet management apparatus 102 may be further configured to transmit the second token information associated with the new user to the first administrator device 106 based on the delegation agreement information between the new user and the first administrator 114. The wallet management apparatus 102 may transmit the second token information to the first administrator device 106 to authorize the first administrator device 106 or the first administrator 114 to initiate transactions on the blockchain network 112 on behalf of the new user.

At 412, the first administrator device 106 may be configured to request for the second transaction on the blockchain network 112 for the new user. The first administrator device 106 may be configured to request for the second transaction for the new user with the received second token information associated with the new user. The first administrator device 106 may be configured to transmit the second token information to the wallet management apparatus 102 to request for the second transaction on the blockchain network 112. The second token information associated with the new user may be utilized by the wallet management apparatus 102 to execute the second transaction on the blockchain network 112. The control of the second transaction on the blockchain network 112 by the wallet management apparatus 102 may be the same as the control of the first transaction on the blockchain network 112 by the wallet management apparatus 102 as described in the sequence of operations from 302 to 316 in FIG. 3.

FIG. 5 depicts a data relationship for blockchain transaction control based on private key management, in accordance with an embodiment of the disclosure. FIG. 5 is explained in conjunction with elements from FIGS. 1, 2, 3, and 4. With reference to FIG. 5, there is shown a data relationship scenario 500. In the data relationship scenario 500 there is shown user information 502 which may further include user identification information 502A. The user identification information 502A may indicate the identification information of the first user 116 or other users associated with the wallet management apparatus 102. Examples of the user identification information 502A of the first user 116 may include, but are not limited to, a user ID (such as “user_id”), a user name, contact details, personal data, work experience data, or academic data.

The user information 502 may further include administrator information 502B which may further include the identification information of the first administrator 114 who may be authorized or delegated to perform transaction on the blockchain network 112 on behalf of the first user 116 or other users linked with the first administrator 114. Examples of the administrator information 502B of the first administrator 114 may include, but are not limited to, an administrator ID (such as “admin_id”), an administrator name, an administrator contacts details, an administrator personal data, or other data related to the first administrator 114.

In FIG. 5, there is further shown token information 504. The token information 504 may indicate the first token information as described, for example, in FIG. 3. The token information 504 may include, but is not limited to, the token identification number (such as “token_id”) and the first private key reference information (such as “pk_ref_id”) as shown in FIG. 5. The user information 502 and the token information 504 may be stored in the first database 104. For example, the user information 502 may be stored in the user-profile list 104A and the token information 504 may be stored in the token list 104D, as shown in FIGS. 1A-1B. In FIG. 5, there is further shown private key information 506 which may include, but is not limited to, the first private key reference information (such as “pk_ref_id”) and the encrypted version of a private key (such as the first private key) associated with a user (such as the first user 116. The wallet management apparatus 102 may link the first token information (received from the first administrator device 106) with the encrypted version of the first private key using the first private key reference information (such as “pk_ref_id”) stored in the token information 504 and the private key information 506 as shown in FIG. 5. In embodiment, the token information 504 and the private key information 506 are stored in different databases associated with the wallet management apparatus 102. In such case, the private key information 506 may be stored in the second database 118 (secured), different from the first database 104. In some embodiments, the private key information 506 may be stored in a secured database associated with another wallet management apparatus (such as wallet management apparatus 120 shown in FIG. 1B) to provide more security to private key information 506 associated with the first user 116. In accordance with an embodiment, the wallet management apparatus 102 may be configured to link or associate the user information 502, the token information 504, and the private key information 506.

In FIG. 5, there is further shown smart contract information 508 which may include the delegation agreement information between the corresponding user and the first administrator 114 as described, for example, in FIGS. 1A-1B. The smart contract information 508 (such as “smart_contract”) may include, but is not limited to, contract identification information (like “contract_id) and a name of the smart contract. The contract identification information (like “contract_id) may indicate a particular contract or the delegation agreement information between the first user 116 the first administrator 114. The smart contract information 508 may be stored in the smart contract information list 104C as shown in FIGS. 1A-1B.

In accordance with an embodiment, the smart contract information 508 may be linked with the administrator information 502B using smart contract (SC) access control information 510 as shown in FIG. 5. The SC access control information 510 may include, but is not limited to, the contract identification information (like “contract_id), the administrator ID (such as “admin_id”), group identification information (such as “group_id”), and level information (“crud”). The level information (“crud”) in the SC access control information 510 may indicate different operations (such as create, read, update, or delete) associated with the smart contract access. The SC access control information 510 may be stored in the first database 104. In an embodiment, the wallet management apparatus 102 may relate the administrator information 502B with the smart contract information 508 using the administrator ID (such as “admin_id”) and the contract identification information (like “contract_id) as shown in FIG. 5. For example, the wallet management apparatus 102 may search the delegation agreement information in the smart contract information 508 for the first administrator 114 based on the stored the administrator ID (such as “admin_id”) and the contract identification information (like “contract_id) stored in the first database 104.

In accordance with an embodiment, the smart contract information 508 may be associated with smart contract (SC) parameter information 512 as shown in FIG. 5. The SC parameter information 512 may include, but is not limited to, the contract identification information (like “contract_id), a name of the SC parameter information 512, and a type of the name. For example, the type of the name may be one of integer type or string type. In an embodiment, the SC parameter information 512 may indicate data (i.e. need to be stored in the blockchain network 112), that may be related to a user (such as the first user 116). The data may be personal data (for example marks of students, contact details, salary details of employee, diagnostic data of patient, etc) associated with the first user 116. In accordance with an embodiment, the SC parameter information 512 may be stored in the smart contract information list 104C in the first database 104. A shown in FIG. 5, the administrator information 502B may be linked or associated with group information 514. The group information 514 may indicate a plurality of users (such as the first user 116) associated with a particular administrator (such as the first administrator 114). For example, the plurality of users may have delegated or authorized the particular administrator to control the transactions on the blockchain network 112 on their behalf. The group information 514 may include, but is not limited to, group identification information (such as group_id), a name of a group, and an administrator of the group. The administrator of the group may be indicated by the administrator ID (such as “admin_id”). The group information 514 may be further associated with group details 516 which may include, but is not limited to, the group identification information (such as group_id) and the user ID (such as “user_id”). In some embodiments, the group details 516 may include a plurality of user IDs indicating the plurality of users (such as the first user 116) associated with the particular administrator (such as the first administrator 114) in a group. For each user, the disclosed wallet management apparatus 102 may store a specific token information (such as the first token information may be associated with the first user 116).

It may be noted that the data relationship between the user information 502, the token information 504, the private key information 506, the smart contract information 508, the SC access control information 510, the SC parameter information 512, and the group information 514 as shown in FIG. 5 is presented merely as an example. The present disclosure may be also applicable to other types of the data relationship for the blockchain transaction control based on private key management. A description of other types of data relationship has been omitted from the disclosure for the sake of brevity.

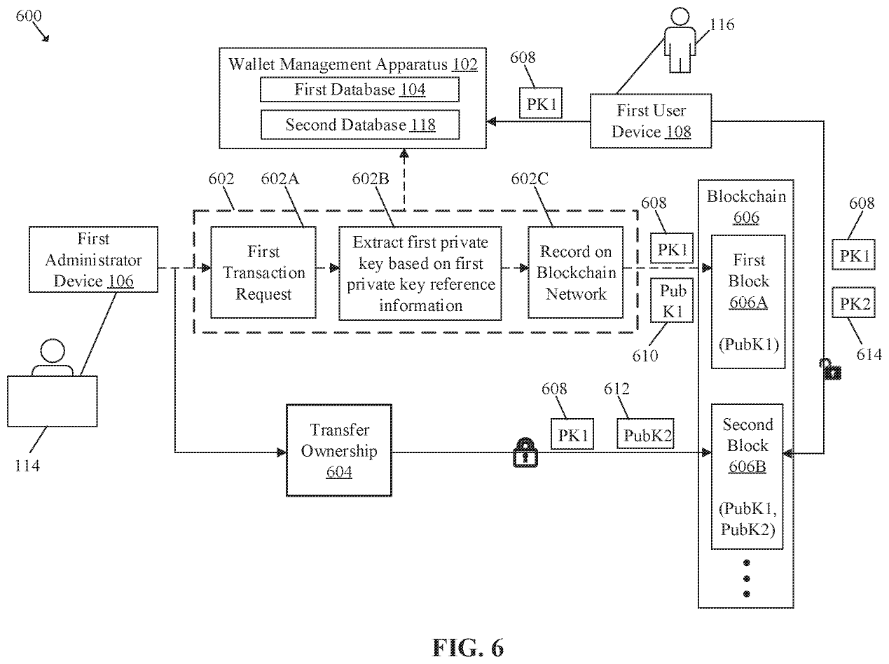

FIG. 6 illustrates exemplary operations for a first scenario of transfer of ownership of transactions on the blockchain network, in accordance with an embodiment of the disclosure. FIG. 6 is described in conjunction with elements from FIGS. 1, 2, 3, 4, and 5. With reference to FIG. 6, there is shown a processing pipeline 600 for a first scenario of transfer of ownership of a transaction on the blockchain network 112. There is further shown, the wallet management apparatus 102, the first database 104, the second database 118, the first administrator device 106, the first user device 108, the first administrator 114, and the first user 116. There is further shown, a blockchain 606 on the blockchain network 112, a first private key 608 (also represented as “PK1”), a first public key 610 (also represented as “PubK1”), a second public key 612 (also represented as “PubK2”), and a second private key 614 (also represented as “PK2”). The blockchain 606 on the blockchain network 112 may include a first block 606A and a second block 606B.

At 602, the operations for control of the first transaction on the blockchain network 112 based on first private key management are shown. The operations for control of the first transaction on the blockchain network 112 based on a first private key management have been described in detail, for example, in FIGS. 1A-1B, FIG. 3, and FIG. 4. The operations for the first transaction on the blockchain network 112 may include steps from 602A to 602C as shown in FIG. 6. At 602A, the first administrator device 106 may be configured to transmit the request for the first transaction for the first user 116 to the wallet management apparatus 102 with the first token information associated with the first user 116. The first user 116 may share the first private key 608 with the wallet management apparatus 102. The first token information may include the first private key reference information which may refer to the encrypted version of the first private key 608 stored in the second database 118. At 602B, the wallet management apparatus 102 may be further configured to extract the first private key 608 associated with the first user device 108 based on the first private key reference information included in the first token information. The extraction of the first private key 608 associated with the first user device 108 is described in detail, for example, in FIGS. 1A-1B and FIG. 3. At 602C, the wallet management apparatus 102 may be further configured to control the first transaction on the blockchain network 112 based on the first private key 608 associated with the first user device 108 and may further record the first transaction on the blockchain network 112. As the first transaction on the blockchain network 112 is recorded, the first block 606A may be stored on the blockchain 606. The blockchain 606 may be a list of records, which may be linked with each other, such that each block may contain a cryptographic data of a previous block, a transaction data of the corresponding block, and a timestamp of the transaction data on the corresponding block. The first block 606A may include data associated with the first transaction. The first block 606A may include the first public key 610 which may be associated or mapped with the data included in the first block 606A for the first transaction.

At 604, an operation for transfer of ownership may be executed. For example, the first user 116 may be at an elementary level (e.g. under an age of 15 years) may request the first administrator 114 to transfer the ownership. The ownership may be transferred to another user (not shown). The other user may be parent or guardian of the first user 116 at the at an elementary level. In some embodiments, the wallet management apparatus 102 may be configured to control the first administrator device 106 to transfer an ownership on the blockchain network 112 to the other user which may be associated with the first user 116.

In certain scenarios, the first user 116 may no longer want the first administrator 114 to initiate the transaction on the blockchain network 112 on behalf of the first user 116. Due to transfer of ownership from the first administrator 114 to other users (for example parent or guardian in case the first user 116 is at the elementary level), any fraudulent transactions (for example unapproved manipulations on the blockchain network 112) made by the first administrator 114 on behalf of the first user 116 can be prevented and enhanced security may be provided for the transaction related to the first user 116 on the blockchain network 112. Since the first user 116 has shared the first private key 608, associated with the first user device 108, with the wallet management apparatus 102, other user (for example parents) may use the first user device 108 to directly execute transactions on the blockchain network 112, after transfer of the ownership. In some embodiments, the other user may use different associated user devices to execute transactions on the blockchain network 112 after ownership transfer. In another example, the first administrator device 106 may no longer be associated with the wallet management apparatus 102 (for example organization associated with the first administrator 114 is closed), and the first user 116 may want to directly execute the transactions on the blockchain network 112 or transfer the ownership to other user (for example parents in case of the first user 116 is minor). In such scenarios, the wallet management apparatus 102 may be further configured to control the first administrator device 106 to transfer the ownership for the first transaction. In accordance with an embodiment, the second private key 614 may be stored in the first user device 108 which may be associated with the first user 116 or with the other user (to whom the ownership has been transferred). The second private key 614 may not be shared with the wallet management apparatus 102. The second private key 614 may be different from the first private key 608.

The wallet management apparatus 102 may be further configured to control the first administrator device 106 to transfer the ownership for the first transaction based on the second public key 612 associated with the first user 116 or the first user device 108. In such case, the first administrator device 106 or the wallet management apparatus 102 may request the first user 116 or the first user device 108 to share the second public key 612 to transfer the ownership. The first administrator device 106 or the wallet management apparatus 102 may be further configured to link the second public key 612 and the first private key 608, and further store the second public key 612 in the first database 104 such that the first user 116 may be able to access. In some embodiments, the wallet management apparatus 102 may control the first administrator device 106 to securely transfer the ownership based on the first private key 608 since the first private key 608 is confidential with the first user 116 associated with the first user device 108.

In accordance with an embodiment, when the ownership of transactions on the blockchain network 112 is transferred, the wallet management apparatus 102 may not be able to complete the first transaction initiated (or any other transaction to be initiated) by the first administrator 114 on behalf of the first user 116 on the blockchain network 112. The first transaction on the blockchain network 112 that may be initiated by the other user (such as parent of the first user 116) may be executed using the first user device 108. The transaction executed, after the ownership transfer, may be completed by using the second private key 614 associated with the first user device 108. In such case, the first private key 608 may be redundant to the wallet management apparatus 102 and further the first administrator device 106 may not be able to use the first private key 608 on the behalf of the first user 116. In some embodiments, the transaction executed, after the ownership transfer, may be completed by using the combination of the first private key 608 and the second private key 614 associated with the first user device 108. Thus, based on the transfer of ownership, the other user associated with the first user 116 may have access to the blockchain 606 that may include the blocks, such as the first block 606A, which may be associated with the transactions completed using the first user device 108. In some embodiment, after the transfer of ownership, the transaction completed may be recorded in the second block 606B in the blockchain 606 on the blockchain network 112. The second block 606B may include the first public key 610 and the second public key 612 linked with data stored in the second block 606B related to the first user 116. The ownership of the first user 116 may be linked with the first public key 610 and the second public key 612 so that only the first user 116 can access that the data stored in the blockchain 606, and the first administrator 114 may not manipulate the stored data. In accordance with an embodiment, after the transfer of ownership, the first user 116 or other user (to whom ownership has been transferred) may directly access the data from the second block 606B using the second private key 614 as shown in FIG. 6. In accordance with an embodiment, the first user device 108 and the first user 116 may again transfer the ownership to the first administrator 114 (or to the first administrator device 106) since the smart contract information in the smart contract information list 104C includes the delegation agreement information between the first user 116 and the first administrator 114 as described, for example, in FIGS. 1 and 4.

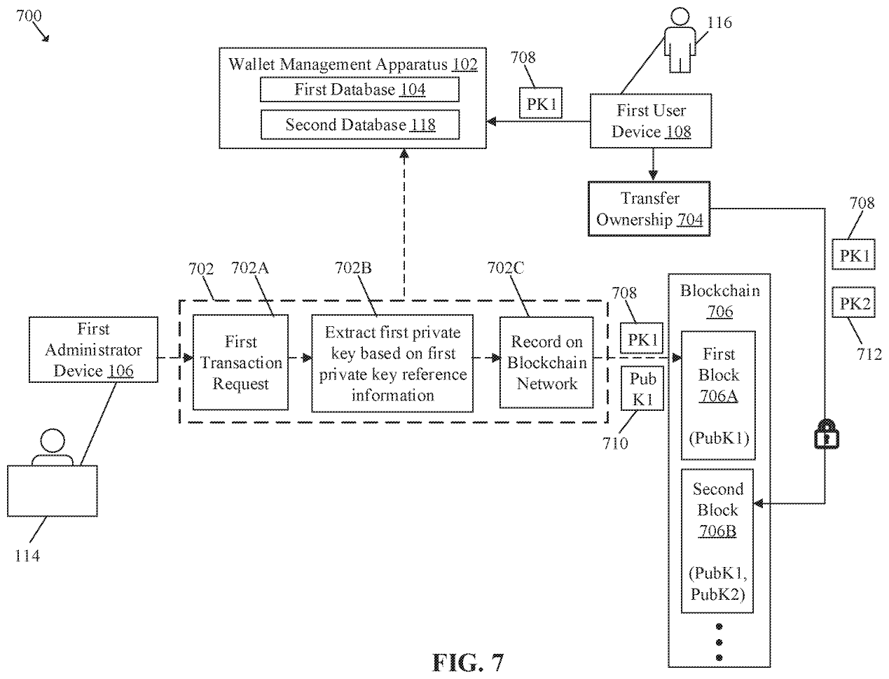

FIG. 7 illustrates exemplary operations for a second scenario for transfer of ownership of transactions on the blockchain network, in accordance with an embodiment of the disclosure. FIG. 7 is described in conjunction with elements from FIGS. 1, 2, 3, 4, 5, and 6. With reference to FIG. 7, there is shown a processing pipeline 700 for a second scenario of transfer of ownership for transactions on the blockchain network 112. There is further shown the wallet management apparatus 102, the first database 104, the second database 118, the first administrator device 106, the first user device 108, the first administrator 114, and the first user 116. There is further shown, a blockchain 706 on the blockchain network 112, a first private key 708 (also represented as “PK1”), a first public key 710 (also represented as “PubK1”), and a second private key 712 (also represented as “PK2”). The blockchain 706 on the blockchain network 112 may include a first block 706A and a second block 706B.

At 702, the operations for control of the first transaction on the blockchain network 112 based on first private key management are shown. The operations for control of the first transaction on the blockchain network 112 based on first private key management have been described in detail, for example, in FIGS. 1A-1B, FIG. 3, and FIG. 4. The operations for the first transaction on the blockchain network 112 may include steps from 702A to 702C as shown in FIG. 7. At 702A, the first administrator device 106 may be configured to transmit the request for the first transaction (for the first user 116) to the wallet management apparatus 102 with the first token information associated with the first user 116. The first user 116 may share the first private key 708 with the wallet management apparatus 102 as shown in FIG. 7. The first token information may include the first private key reference information which may refer to the encrypted version of the first private key 708 stored in the second database 118. At 702B, the wallet management apparatus 102 may be further configured to extract the first private key 708 associated with the first user device 108 based on the first private key reference information included in the first token information. The extraction of the first private key 708 associated with the first user device 108 is described in detail, for example, in FIG. 1A and FIG. 3. At 702C, the wallet management apparatus 102 may be further configured to control the first transaction on the blockchain network 112 based on the first private key 708 associated with the first user device 108 and may further configured to record the first transaction on the blockchain network 112. As the first transaction on the blockchain network 112 is recorded, the first block 706A may be stored on the blockchain 706. The first block 706A may include data associated with the first transaction. In some embodiments, the first block 706A may include the first public key 710.

At 704, an operation for transfer of ownership may be executed. For example, in the second scenario (shown in FIG. 7) the first user 116 may be at a graduate level (e.g. above an age of 15 years) and may himself (or herself) transfer the ownership from the first administrator 114. The ownership may be transferred to the first user 116. In the operation for the transfer of ownership, the wallet management apparatus 102 may be configured to control the first user device 108 associated with the first user 116 to transfer an ownership for the transactions on the blockchain network 112. In such cases, the first user 116 may no longer want the first administrator device 106 or the first administrator 114 to initiate or control the transaction on the blockchain network 112 on behalf of the first user 116. Thus, the first user device 108 may transfer the ownership for the first transaction on the blockchain network 112 to the first user 116. Since the first user 116 has shared the first private key 708 with the wallet management apparatus 102, the first user 116 may use the first user device 108 (or another user device) to directly execute transactions on the blockchain network 112, after transfer of the ownership. In some embodiments, the wallet management apparatus 102 may control the first administrator device 106 to securely transfer the ownership to the first user 116 based on the first private key 608, since the first private key 708 is confidential with the first user 116 and stored in the databases of the wallet management apparatus 102.

In accordance with an embodiment, when the ownership of the first transaction is transferred to the first user 116 or the first user device 108, the wallet management apparatus 102 may not be able to complete the first transaction initiated or controlled by the first administrator 114 on behalf of the first user 116 on the blockchain network 112. Based on the transfer of ownership, the first user 116 associated with the first user device 108 may execute a transaction on the blockchain network 112 by using the second private key 712. In some embodiments, the transaction executed, after the ownership transfer, may be completed by using the combination of the first private key 708 and the second private key 712 associated with the first user device 108. In accordance with an embodiment, the second private key 712 (i.e. different from the first private key 708) may be stored in the first user device 108 associated with the first user 116. The second private key 712 may not be shared with the wallet management apparatus 102.

Further, the first user 116 may have also an access to the blockchain 706 that may include the blocks, such as the first block 706A, associated with the transactions completed using the first user device 108. The transaction completed using the first user device 108 after the transfer of ownership, may be recorded in the second block 706B in the blockchain 706 on the blockchain network 112. The second block 706B may include the first public key 710 and a second public key associated with the first user 116. The second public key may be linked with data stored in the second block 706B related to the first user 116. The wallet management apparatus 102 may be configured to control the linking of the first private key 708 and the first public key 710 and the linking of the second private key 712 and the second public key for the ownership with the first user 116. In accordance with an embodiment, after the transfer of ownership, the first user 116 may directly access the data from the second block 706B using the second private key 712 associated with the first user device 108 as shown in FIG. 7.

In accordance with an embodiment, the first user device 108 and the first user 116 may again transfer the ownership to the first administrator 114 (or to the first administrator device 106) since the smart contract information in the smart contract information list 104C includes the delegation agreement information between the first user 116 and the first administrator 114 as described, for example, in FIGS. 1A and 4.

In an accordance with an embodiment, the disclosed wallet management apparatus 102 may be configured to control a transfer of a user device (such as the first user device 108). For example, when the first user 116 changes the associated device (such as change from the first user device 108 to a new user device), the wallet management apparatus 102 may control the change or transfer of the associated new device. In a case, when the new user device is a smart phone (for example), the new user device may be configured to install an application and receive inputs from the first user 116 for authentication. The wallet management apparatus 102 may be further configured to control the transactions on the blockchain network 112 initiated directly from the new user device (through the installed application) or initiated on behalf of the new user device by the first administrator 114. In another case, when the new user device is a laptop or personal computer (for example), the new user device may access or control the transaction on the blockchain network 112, through a web-site associated with the blockchain network 112.

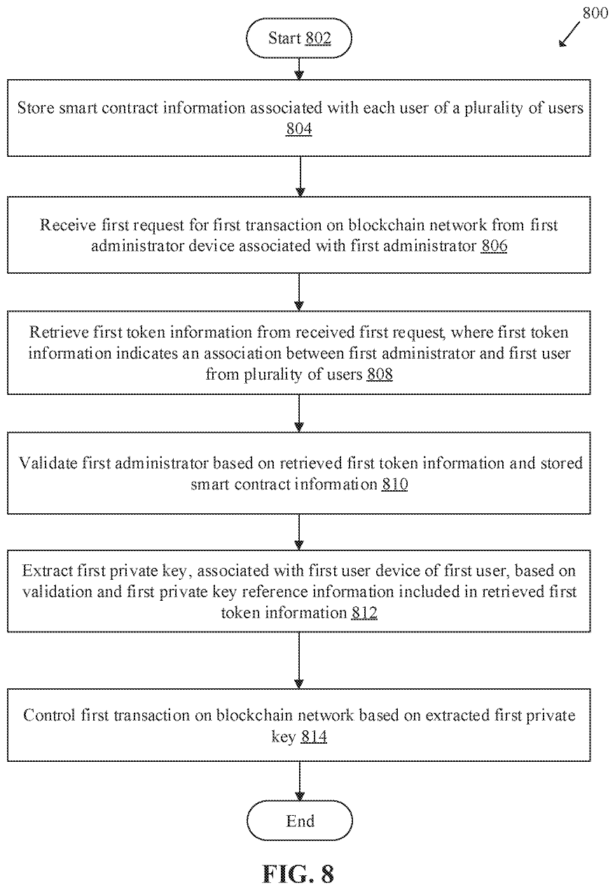

FIG. 8 is a flowchart that illustrates an exemplary method for blockchain transaction control based on private key management, in accordance with an embodiment of the disclosure. FIG. 8 is described in conjunction with elements from FIGS. 1, 2, 3, 4, 5, 6, and 7. With reference to FIG. 8, there is shown a flowchart 800. The exemplary method of the flowchart 800 may be executed by the wallet management apparatus 102. The operations may start at 802 and proceed to 804.

At 804, smart contract information associated with each user of a plurality of users may be stored. The smart contract information may include delegation agreement information between each user of the plurality of users and a first administrator. In accordance with an embodiment, the memory 204 of the wallet management apparatus 102 may be configured to store the smart contract information.

At 806, a first request for a first transaction on the blockchain network 112 may be received from the first administrator device 106 associated with the first administrator 114. The wallet management apparatus 102 may be configured to receive the first request for the first transaction on the blockchain network 112 from the first administrator device 106. The first request for the first transaction may be for the first user 116. The first administrator device 106 may be configured to request for the first transaction on behalf of the first user 116.

At 808, first token information may be retrieved from the received first request, where the first token information may indicate an association between the first administrator 114 and the first user 116 from the plurality of users. The wallet management apparatus 102 may be configured to retrieve the first token information from the received first request as described in detail, for example in FIG. 3.

At 810, the first administrator 114 may be validated based on the retrieved first token information and the stored smart contract information. The wallet management apparatus 102 may be configured to validate the first administrator 114 based on the retrieved first token information and the stored smart contract information. The wallet management apparatus 102 may be further configured to validate the first administrator 114 and the first administrator device 106, based on the delegation agreement information between the first user 116 and the first administrator 114. The delegation agreement information between the first user 116 and the first administrator 114 may indicate that the first administrator 114 may be delegated or authorized to initiate the first transaction on the blockchain network 112 for the first user 116. The validation of the first administrator 114 and the first administrator device 106 has been described, for example, in FIGS. 1A-1B and FIG. 3.

At 812, the first private key associated with the first user device 108 of the first user 116 may be extracted based on the validation and the first private key reference information included in the retrieved first token information. The wallet management apparatus 102 may be configured to extract the first private key associated with the first user device 108 of the first user 116. The first token information (associated with the first user 116) retrieved from the first request may include the first private key reference information that may provide reference to the encrypted version of the first private key associated with the first user device 108. The wallet management apparatus 102 may be further configured to decrypt the encrypted version of the first private key retrieved based on the first private key reference information in the retrieved first token information. The wallet management apparatus 102 may be further configured to extract the first private key based on the decryption of the encrypted version of the first private key. In some embodiments, the wallet management apparatus 102 may be further configured to extract the first private key (associated with the first user device 108) from the plurality of private keys stored in the private key information 104B in the first database 104. The extraction of the first private key has been described in detail, for example, in FIG. 3.

At 814, the first transaction may be controlled on the blockchain network 112 based on the extracted first private key. The wallet management apparatus 102 may be configured to control the first transaction on the blockchain network 112, based on the extracted first private key of the first user device 108. The wallet management apparatus 102 may be further configured to execute the first transaction on the blockchain network 112 by use of the first administrator device 106 associated with the first administrator 114, based on the validation of the first administrator device 106. The wallet management apparatus 102 may be further configured to block the first transaction requested on the blockchain network 112, based on an invalidation of the first administrator 114. The control of the first transaction on the blockchain network 112 has been described in detail, for example, in FIG. 1A and FIG. 3. The control may pass to end.

Various embodiments of the disclosure may provide a non-transitory, computer-readable medium and/or storage medium, and/or a non-transitory machine readable medium and/or storage medium stored thereon, instructions executable by a machine and/or a computer, such as a wallet management apparatus, for blockchain transaction control based on private key management. The instructions may cause the machine and/or computer to perform operations that include storage of smart contract information associated with each user of a plurality of users. The smart contract information includes delegation agreement information between each user of the plurality of users and a first administrator. The operations further include reception of a first request for a first transaction on a blockchain network from a first administrator device associated with the first administrator. The operations further include retrieval of first token information from the received first request. The first token information indicates an association between the first administrator and a first user from the plurality of users. The operations further include validation of the first administrator based on the retrieved first token information and the stored smart contract information. The operations further include extraction of a first private key, associated with a first user device of the first user, based on the validation and on first private key reference information included in the retrieved first token information. The operations further include control of the first transaction on the blockchain network based on the extracted first private key.

Exemplary aspects of the disclosure may include the wallet management apparatus 102 that includes the circuitry 202 and the memory 204. The memory 204 may be configured to store smart contract information associated with each user of a plurality of users. The smart contract information may include delegation agreement information between each user of the plurality of users and a first administrator 114. The circuitry 202 may be configured to receive a first request for a first transaction on the blockchain network 112 from the first administrator device 106 associated with the first administrator 114. The circuitry 202 may be further configured to retrieve first token information from the received first request. The first token information may indicate an association between the first administrator 114 and the first user 116 from the plurality of users. The circuitry 202 may be further configured to validate the first administrator 114 based on the retrieved first token information and the stored smart contract information. The circuitry 202 may be further configured to extract a first private key, associated with the first user device 108 of the first user 116, based on the validation and on first private key reference information included in the retrieved first token information. The circuitry 202 may be further configured to control the first transaction on the blockchain network 112 based on the extracted first private key.

In accordance with an embodiment, the circuitry 202 may be further configured to receive a second request for a second transaction on the blockchain network 112 from a new user. The new user may be different from each user of the plurality of users. The circuitry 202 may be further configured to generate a second private key associated with a user device of the new user based on the received second request. The circuitry 202 may be further configured to generate second token information that indicates an association between the first administrator 114 and the new user. The circuitry 202 may be further configured to transmit the generated second token information to the first administrator device 106 associated with the first administrator 114. The generated second token information may correspond to identification information of the new user, identification information of the first administrator 114, a token identification number, second private key reference information which provides a reference to an encrypted version of the second private key associated with the user device of the new user, and new delegation agreement information between the new user and the first administrator 114. The circuitry 202 may be further configured to update the stored smart contract information for the new user based on the new delegation agreement information between the new user and the first administrator 114.

In accordance with an embodiment, the first token information may include the first private key reference information which may provide a reference to an encrypted version of the first private key associated with the first user device 108. The circuitry 202 may be further configured to decrypt the encrypted version of the first private key retrieved based on the first private key reference information. The circuitry 202 may be further configured to extract the first private key associated with the first user device 108 based on the decryption of the encrypted version of the first private key. In accordance with an embodiment, the memory 204 may be further configured to store a plurality of private keys each of which is associated with corresponding user of the plurality of users. The circuitry 202 may be further configured to extract the first private key from the stored plurality of private keys based on the retrieved first token information and the validation.

In accordance with an embodiment, the memory 204 may be further configured to store user-profile information associated with each of the plurality of users and a token list (for example the token list 104D) that includes token information associated with each of the plurality of users. The circuitry 202 may be further configured to determine a presence of the retrieved first token information associated with the first user 116 in the token list 104D. The circuitry 202 may be further configured to validate the first administrator 114 based on the determined presence of the retrieved first token information in the token list 104D. The circuitry 202 may be further configured to update the token list 104D based on a change in the token information associated with each of the plurality of users. The circuitry 202 may be further configured to validate the first administrator 114 and the first administrator device 106, based on the delegation agreement information between the first user 116 and the first administrator 114. The circuitry 202 may be further configured to execute the first transaction on the blockchain network 112 by use of the first administrator device 106 associated with the first administrator 114, based on the extracted first private key. The circuitry 202 may be further configured to block the first transaction requested on the blockchain network 112, based on an invalidation of the first administrator 114.

The circuitry 202 may be further configured to transmit a notification for completion of the first transaction on the blockchain network 112 to the first administrator device 106 which is associated with the first administrator 114 and to the first user device 108 which is associated with the first user 116, based on the validation. In accordance with an embodiment, the circuitry 202 may be further configured to control the first administrator device 106 to transfer an ownership for the first transaction on the blockchain network 112 to the first user device associated with the first user 116. The transfer of ownership may be controlled, based on a public key associated with the second user device of the first user 116 and a second private key associated with the second user device of the first user 116. The second private key may be different from the first private key. In accordance with an embodiment, the circuitry 202 may be further configured to control the first user device 108 associated with the first user 116 to transfer an ownership for the first transaction on the blockchain network 112 to the first user device associated with the first user 116. The transfer of ownership may be controlled, based on a second private key associated with the second user device of the first user 116.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features that enable the implementation of the methods described herein, and which when loaded in a computer system is able to carry out these methods. Computer program, in the present context, means any expression, in any language, code or notation, of a set of instructions intended to cause a system with information processing capability to perform a particular function either directly, or after either or both of the following: a) conversion to another language, code or notation; b) reproduction in a different material form.

While the present disclosure is described with reference to certain embodiments, it will be understood by those skilled in the art that various changes may be made and equivalents may be substituted without departure from the scope of the present disclosure. In addition, many modifications may be made to adapt a particular situation or material to the teachings of the present disclosure without departure from its scope. Therefore, it is intended that the present disclosure not be limited to the particular embodiment disclosed, but that the present disclosure will include all embodiments that fall within the scope of the appended claims

What is claimed is:

1. A wallet management apparatus, comprising:
a memory configured to store smart contract information associated with each user of a plurality of users, wherein the smart contract information includes delegation agreement information between each user of the plurality of users and a first administrator;
circuitry, coupled with the memory, wherein the circuitry is configured to:
receive a first request for a first transaction on a blockchain network from a first administrator device associated with the first administrator;
retrieve first token information from the received first request, wherein the first token information indicates an association between the first administrator and a first user from the plurality of users;
validate the first administrator based on the retrieved first token information and the stored smart contract information;
extract a first private key, associated with a first user device of the first user, based on the validation and on first private key reference information included in the retrieved first token information; and
control the first transaction on the blockchain network based on the extracted first private key.

2. The wallet management apparatus according to claim 1, wherein the circuitry is further configured to:
receive a second request for a second transaction on the blockchain network from a new user, wherein the new user is different from each user of the plurality of users; and
generate a second private key associated with a user device of the new user based on the received second request.

3. The wallet management apparatus according to claim 2, wherein the circuitry is further configured to:
generate second token information that indicates an association between the first administrator and the new user; and
transmit the generated second token information to the first administrator device associated with the first administrator.

4. The wallet management apparatus according to claim 3, wherein the generated second token information corresponds to identification information of the new user, identification information of the first administrator, a token identification number, second private key reference information which provides a reference to an encrypted version of the second private key associated with the user device of the new user, and new delegation agreement information between the new user and the first administrator.

5. The wallet management apparatus according to claim 4, wherein the circuitry is further configured to update the stored smart contract information for the new user based on the new delegation agreement information between the new user and the first administrator.

6. The wallet management apparatus according to claim 1, wherein the first token information includes the first private key reference information which provides a reference to an encrypted version of the first private key associated with the first user device, and wherein the circuitry is further configured to:
decrypt the encrypted version of the first private key retrieved based on the first private key reference information; and
extract the first private key associated with the first user device based on the decryption of the encrypted version of the first private key.

7. The wallet management apparatus according to claim 1, wherein the memory is further configured to store a plurality of private keys each of which is associated with corresponding user of the plurality of users, and
wherein the circuitry is further configured to extract the first private key from the stored plurality of private keys based on the retrieved first token information and the validation.

8. The wallet management apparatus according to claim 1, wherein the memory is further configured to store user-profile information associated with each of the plurality of users and a token list that includes token information associated with each of the plurality of users.

9. The wallet management apparatus according to claim 8, wherein the circuitry is further configured to:
determine a presence of the retrieved first token information associated with the first user in the token list; and
validate the first administrator based on the determined presence of the retrieved first token information in the token list.

10. The wallet management apparatus according to claim 8, wherein the circuitry is further configured to update the token list based on a change in the token information associated with each of the plurality of users.

11. The wallet management apparatus according to claim 1, wherein the circuitry is further configured to validate the first administrator and the first administrator device, based on the delegation agreement information between the first user and the first administrator.

12. The wallet management apparatus according to claim 11, wherein, based on the extracted first private key, the circuitry is further configured to execute the first transaction on the blockchain network by use of the first administrator device associated with the first administrator.

13. The wallet management apparatus according to claim 1, wherein the circuitry is further configured to block the first transaction requested on the blockchain network, based on an invalidation of the first administrator.

14. The wallet management apparatus according to claim 1, wherein the circuitry is further configured to transmit a notification for completion of the first transaction on the blockchain network to the first administrator device which is associated with the first administrator and to the first user device which is associated with the first user, based on the validation.

15. The wallet management apparatus according to claim 1, wherein the circuitry is further configured to control the first administrator device to transfer an ownership for the first transaction on the blockchain network to the first user device associated with the first user, based on a public key associated with the first user device of the first user and a second private key associated with the first user device of the first user, and
wherein the second private key is different from the first private key.

16. The wallet management apparatus according to claim 1, wherein the circuitry is further configured to control the first user device associated with the first user to transfer an ownership for the first transaction on the blockchain network to the first user device associated with the first user, based on a second private key associated with the second user device of the first user, and
wherein the second private key is different from the first private key.

17. A method, comprising:
in a wallet management apparatus:
storing smart contract information associated with each user of a plurality of users, wherein the smart contract information includes delegation agreement information between each user of the plurality of users and a first administrator;
receiving a first request for a first transaction on a blockchain network from a first administrator device associated with the first administrator;
retrieving first token information from the received first request, wherein the first token information indicates an association between the first administrator and a first user from the plurality of users;
validating the first administrator based on the retrieved first token information and the stored smart contract information;
extracting a first private key, associated with a first user device of the first user, based on the validation and on first private key reference information included in the retrieved first token information; and
controlling the first transaction on the blockchain network based on the extracted first private key.

18. The method according to claim 17, further comprising:
validating the first administrator and the first administrator device, based on the delegation agreement information between the first user and the first administrator.

19. The method according to claim 17, further comprising:
transmitting a notification for completion of the first transaction on the blockchain network to the first administrator device which is associated with the first administrator and to the first user device which is associated with the first user, based on the validation.

20. The method according to claim 17, wherein the first token information includes the first private key reference information which provides a reference to an encrypted version of the first private key associated with the first user device, and the method further comprising:
decrypting the encrypted version of the first private key retrieved based on the first private key reference information; and
extracting the first private key associated with the first user device based on the decryption of the encrypted version of the first private key.
